(19) United States
(12) Patent Application Publication
(10) Pub. No.: US 2023/0227071 A1
(43) Pub. Date: Jul. 20, 2023

(54) Latency Violation Prevention for Autonomous Vehicle Control Systems

(71) Applicant: GM Cruise Holdings LLC, SAN FRANCISCO, CA (US)

(72) Inventor: Burkay Donderici, Burlingame, CA (US)

(21) Appl. No.: 17/579,779

(22) Filed: Jan. 20, 2022

(51) Int. Cl. B60W 60/00; G07C 5/08

(52) U.S. Cl. CPC B60W 60/0015; G07C 5/0808

(57) ABSTRACT

Disclosed are systems, apparatuses, methods, and computer-readable media to autonomous driving vehicles and, in particular, for preventing latency violations in autonomous vehicle control systems. A method includes navigating the autonomous vehicle into first region of an environment at a first time, determining a runtime performance of the autonomous vehicle control system in the first region based on the environment, recording the runtime performance into runtime information of the autonomous vehicle, and determining a route to a destination location for the autonomous vehicle to navigate based on mapping information determined based on the runtime information.

### TECHNICAL FIELD

The subject technology is related to autonomous driving vehicles and, in particular, for preventing latency violations in autonomous vehicle control systems.

### BACKGROUND

Autonomous vehicles are vehicles having computers and control systems that perform driving and navigation tasks that are conventionally performed by a human driver. As autonomous vehicle technologies continue to advance, ride-sharing services will increasingly utilize autonomous vehicles to improve service efficiency and safety. However, autonomous vehicles will be required to perform many of the functions that are conventionally performed by human drivers, such as avoiding dangerous or difficult routes, and performing other navigation and routing tasks necessary to provide safe and efficient transportation. Such tasks may require the collection and processing of large quantities of data disposed on the autonomous vehicle.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example of an autonomous vehicle (AV) management system according to an example of the instant disclosure;

FIG. 2 illustrates an example diagram of a Continuous Learning Machine (CLM) for resolving uncommon scenarios in an AV according to an example of the instant disclosure;

FIG. 3 illustrates an example of an AV control system and intervals of a single cycle of an AV control schedule according to an example of the instant disclosure;

FIG. 4 illustrates an example method of a control system for monitoring and predicting latency violations in accordance with some examples;

FIG. 5 illustrates an example method of a control system for monitoring an AV control system for latency violations and controlling the AV control system based on latency violations in accordance with some examples;

FIG. 6 illustrates an example heatmap having a plurality of visual indicators that can be used by an AV control system to perform navigation functions according to an example of the instant disclosure; and

FIG. 7 illustrates an example of a computing system according to an example of the instant disclosure.

### DETAILED DESCRIPTION

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

An autonomous vehicle (AV) includes a control system that controls various functions that are conventionally performed by a human driver, such as perception of objects in the environment and controlling navigation functions of the AV (e.g., acceleration, braking, turning, etc.). Various sensors of the AV produce data at different data rates for the AV control system, and the AV control system may timely process the information to make decisions to safely navigate the AV in the environment. In some cases, the AV control system may need to process a volume of information due to a busy environment, which can create latency in the AV control system and increase reaction time for events that occur in the environment, and increase potential risks that can have adverse effects.

Systems, methods, and computer-readable media are disclosed for predicting latency violations in an AV control system. In some examples, the AV control system may determine regions between a current location and a destination location and predict whether latency violations may occur in those regions based on environmental conditions. The method of the AV control system includes navigating the AV into a first region of an environment at a first time, determining a runtime performance of the AV control system in the first region based on the environment, recording the runtime performance into runtime information of the AV, and determining a route to a destination location for the AV to navigate based on mapping information determined based on the runtime information.

In one example, the AV control system may be configured to detect environmental conditions such as weather or lighting conditions and may generate a heat map to determine how to navigate the AV based on the heat map. In other examples, the AV may record data related to runtime performance and may provide the runtime performance to a machine learning (ML) system for training neural network models for prediction functions. The ML system may be configured to generate heat maps that are provided to staff, which use the heat maps to manage operational parameters of AVs within the fleet. The ML system may also be configured to generate a heatmap and transmit a heatmap for the AV based on data accumulated from AVs within the fleet.

In some other examples, the AV control system can determine that a safety condition has been satisfied based on latency violations associated with various functions of the AV control system. In response to the safety condition, the AV control system can adjust operating parameters to maintain a reaction time for the AV. These and other improvements yield an improvement in an AV control system to safely navigate the AV while experiencing adverse conditions such as a heavy rain or snow.

### Example Embodiments

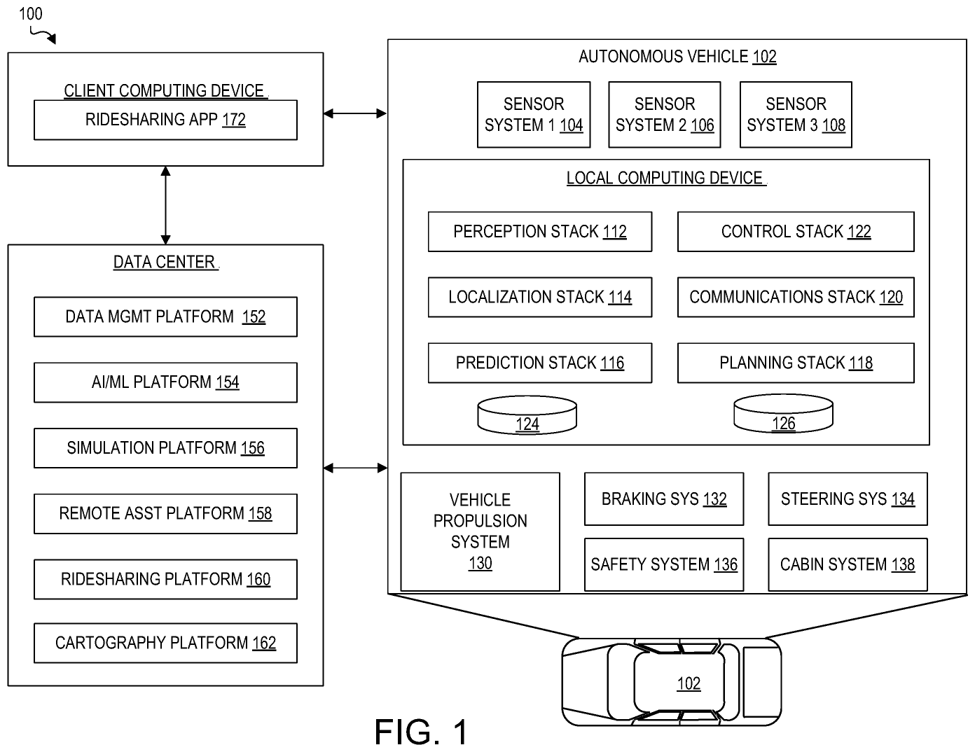

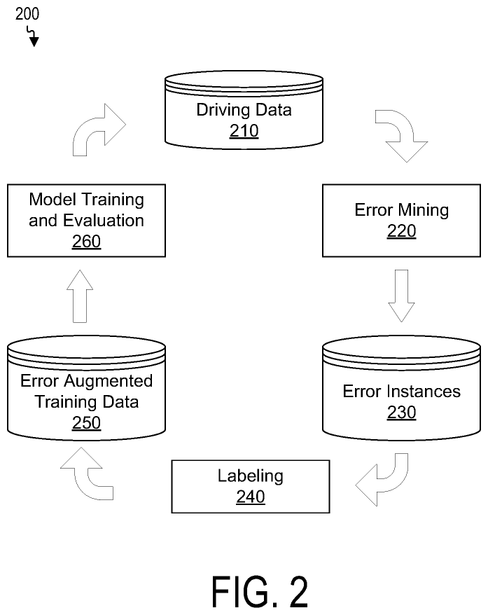

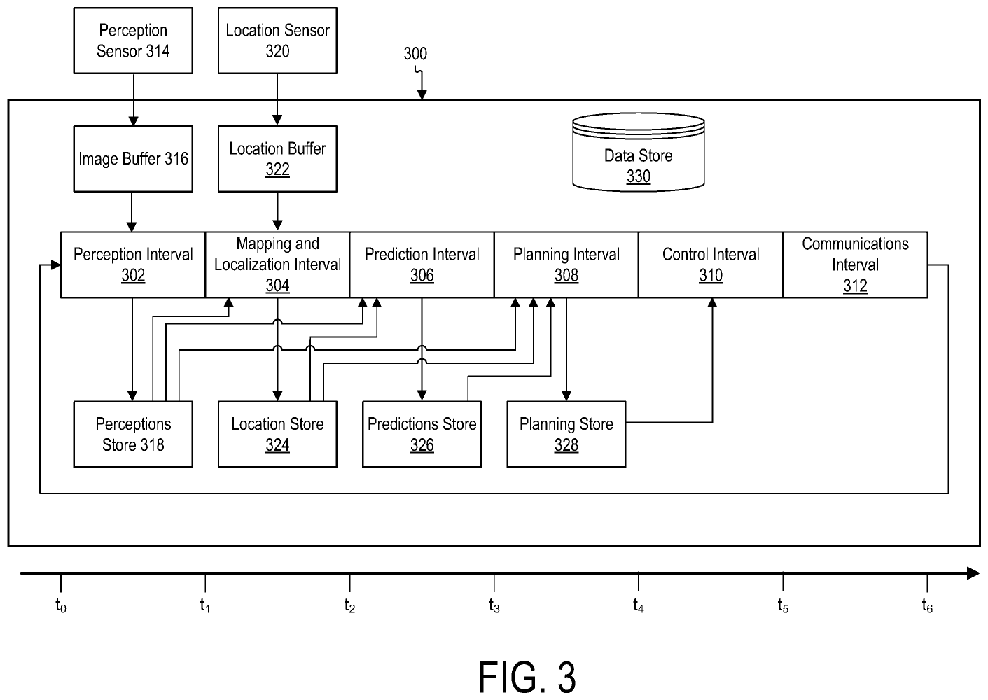

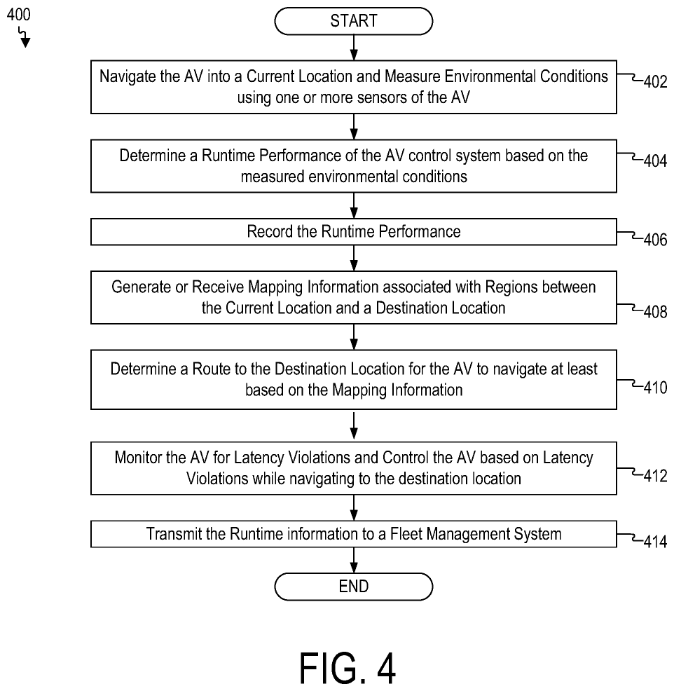

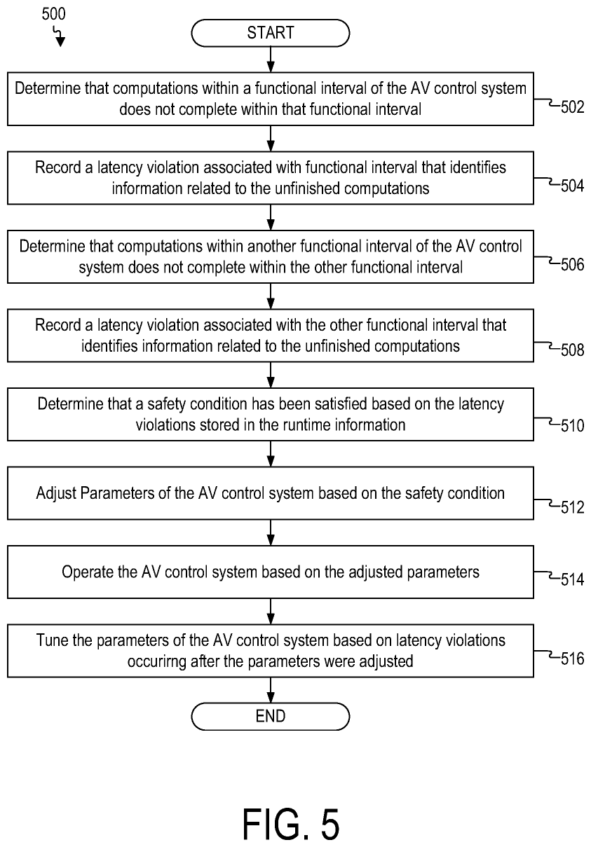

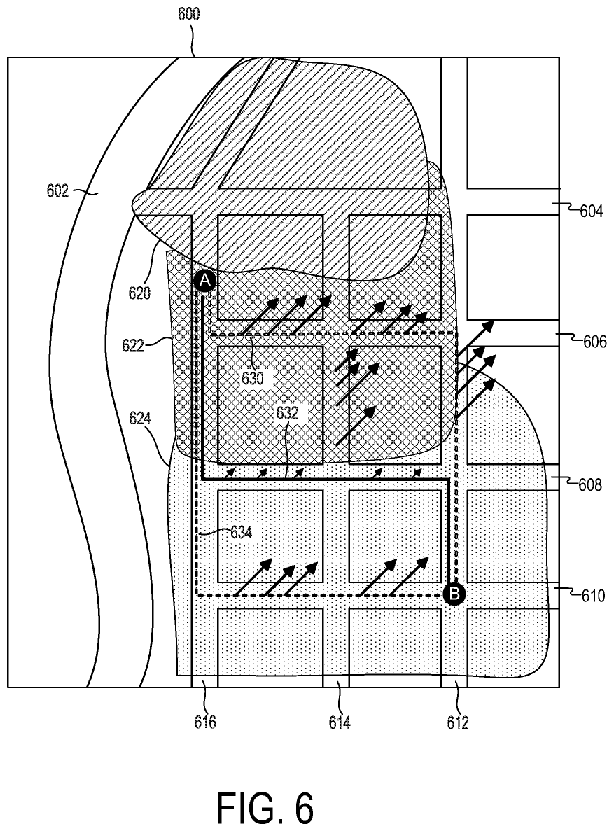

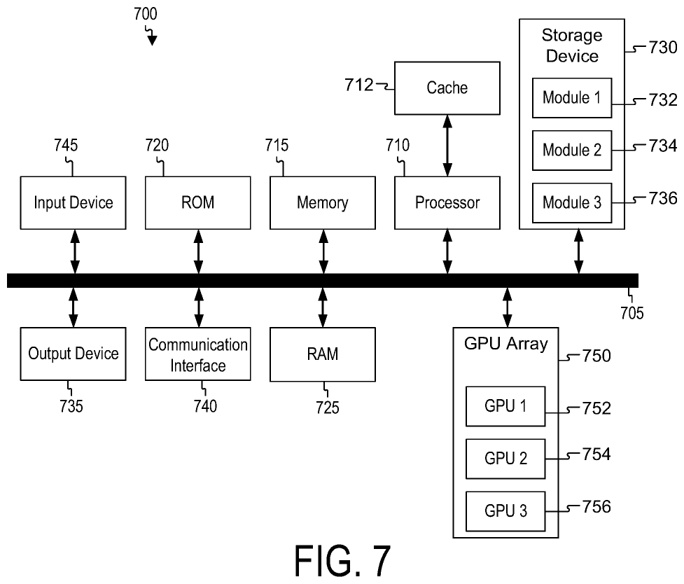

A description of an AV management system and a continual learning machine (CLM) for the AV management system, as illustrated in FIGS. 1 and 2, are first disclosed herein. An overview of an AV control system is disclosed in FIG. 3 and methods associated with the AV control system are disclosed in FIGS. 4 and 5. A heatmap used by the AV control system is illustrated in FIG. 6. The discussion then concludes with a brief description of example devices, as illustrated in FIG. 7. These variations shall be described herein as the various embodiments are set forth. The disclosure now turns to FIG. 1.

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., light detection and ranging (LIDAR) systems, ambient light sensors, infrared sensors, etc.), RADAR systems, global positioning system (GPS) receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and a high definition (HD) geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.). In some examples, the perception stack can also perceive environmental conditions of the AV 102 such as lighting and weather conditions to facilitate perception tasks and other tasks that consider the environmental conditions such as raining, snow, poor visibility in the human visibility spectrum, and the like.

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources. In some examples, the mapping and localization stack 114 may also receive the environmental conditions associated with the AV 102 to facilitate the determination of the AV's position and orientation.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the cartography platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the cartography platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the cartography platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

FIG. 2 illustrates an example diagram of a CLM 200 that solves uncommon scenarios in a rank-frequency distribution, which may be referred to long-tail prediction problem, in an AV in accordance with some examples. The CLM 200 is a continual loop that iterates and improves based on continual feedback to learn and resolve driving situations experienced by the AV.

The CLM 200 begins with a fleet of AVs that are outfitted with sensors to record a real-world driving scene. In some cases, the fleet of AVs is situated in a suitable environment that represents challenging and diverse situations such as an urban environment to provide more learning opportunities. The AVs record the driving situations into a collection of driving data 210.

The CLM 200 includes an error mining 220 to mine for errors and uses active learning to automatically identify error cases and scenarios having a significant difference between prediction and reality, which are added to a dataset of error instances 230. The error instances are long-tail scenarios that are uncommon and provide rich examples for simulation and training. The error instances 230 store high-value data and prevent storing datasets with situations that are easily resolved.

The CLM 200 also implements a labeling function 240 that includes both automated and manual data annotation of data that is stored in error augmented training data 250 and used for future prediction. The automated data annotation is performed by an ML labeling annotator that uses a neural network trained to identify and label error scenarios in the datasets. Using the ML labeling annotator enables significant scale, cost, and speed improvements that allow the CLM 200 to cover mores scenario of the long tail. The labeling function 240 also includes functionality to allow a human annotator to supplement the ML labeling function. By having both an automated ML labeling function and a manual (human) labeling annotator, the CLM 200 can be populated with dense and accurate datasets for prediction.

The final step of the CLM 200 is model training and evaluation 260. A new model (e.g., a neural network) is trained based on the error augmented training data 250 and the new model is tested extensively using various techniques to ensure that the new model exceeds the performance of the previous model and generalizes well to the nearly infinite variety of scenarios found in the various datasets. The model can also be simulated in a virtual environment and analyzed for performance. Once the new model has been accurately tested, the new model can be deployed in an AV to record driving data 210. The CLM 200 is a continual feedback loop that provides continued growth and learning to provide accurate models for an AV to implement.

In practice, the CLM can handle many uncommon scenarios, but the AV will occasionally need to account for new and infrequency scenarios that would be obvious to a human. For example, an AV may encounter another motorist making an abrupt and sometimes illegal U-turn. The U-turn can be at a busy intersection or could be mid-block, but the U-turn will be a sparse data point as compared to more common behaviors such as moving straight, left turns, right turns, and lane changes. Applying our CLM principles, an initial deployment model may not optimally predict U-turn situations and error situations commonly include U-turns. As the dataset grows and more error scenarios of U-turns are identified, the model can be trained to sufficiently predict a U-turn and allow the AV to accurately navigate this scenario.

The CLM 200 can be applied to any number of scenarios that a human will intuitively recognize including, for example, a K-turn (or a 3-point turn), lane obstructions, construction, pedestrians, animated objects, animals, emergency vehicles, funeral processions, jaywalking, and so forth. The CLM 200 provides a mechanism for continued learning to account for diverse scenarios that are present in the physical world.

FIG. 3 illustrates an example of an AV control system 300 and intervals of a single cycle of an AV control schedule according to an example of the instant disclosure.

In some examples, the AV control system 300 includes an AV control schedule that executes at a frequency (e.g., 10 Hz) and includes a number of intervals in each cycle that coordinate time-sensitive resources of the AV to navigate the environment. Each sensor is different and can emit data at different data rates that the AV control system 300 uses to perform its functions. For example, the LIDAR detector LIDAR sensor is configured to emit light to measure distances and may rotate a full 360° sweep at a rate of 10 Hz and a point cloud from the LIDAR detector is output every full 360° sweep (e.g., 10 Hz or 100 ms). Image sensors fixed to the AV may capture a plurality of images to perform object detection and estimate object movement and the image sensors can be configured to output captured images and store the images in a buffer at a rate of 30 Hz, for example. The AV control system 300 is configured to receive and process the sensed information to allow the AV control system 300 to quickly react to changes in the environment.

The example AV control system 300 includes a perception interval 302 that executes between t₀ and t₁, a mapping and localization interval 304 that executes between t₁ and t₂, a prediction interval 306 that executes between t₂ and t₃, a planning interval 308 that executes between t₃ and t₄, a control interval 310 that executes between t₄ and t₅, and a communication interval 312 that executes between t₅ and t₆. In some examples, each of the intervals executes in 16.6 ms and the execution of each cycle of the AV control system 300 consumes 100 ms. After the completion of a single cycle of the AV control schedule, the complete cycle is repeated.

In some examples, at least one perception sensor 314 (e.g., an image sensor, a LIDAR detector, a radar, an ultrasonic detector, etc.) is configured to detect information and send the detected information to the AV control system 300. The perception sensor 314 can provide information on a fixed basis (e.g., 30 Hz) that is stored in a buffer 316. In some examples, the buffer 316 is configured as a first-in first-out (FIFO) buffer to provide information to the AV control system 300. During the perception interval 302, the AV control system 300 is configured to sequentially access the detected information from the buffer 316 to perform functions of the perception stack 112. The AV control system 300 can detect and classify objects and determine their current locations, speeds, directions, and the like and track any changes across time.

The AV control system 300 may be configured to store the output of the perception stack 112 (e.g., detected objects) into the perception store 318. In some examples, the perception store includes multiple buffers that the AV control system 300 may access during other intervals such as the prediction interval 306 and the planning interval 308.

In some cases, the AV control system 300 may not be able to identify all objects in the environment of the AV due to various environmental conditions and time. In one illustrative example, the AV may be located in a region that is experiencing heavy rainfall and the rain can degrade the performance of various sensors such as the LIDAR detector and image sensors. As a result of too many objects in the environment and degraded performance of the LIDAR detector and image sensors, the complexity of the object detection function increases, and the AV control system 300 may not be able to process all data within the image buffer 316.

When the AV control system 300 is unable to perform all functions of a particular interval (e.g., the perception interval 302, etc.), a latency violation occurs. The AV control system 300 may be configured to store data that identifies the latency violation in a data store 330. In one illustrative example, the AV control system 300 is configured to identify data stored in a buffer of the image buffer 316 that indicates that the data from that perception interval 302 of an AV control cycle did not complete. The AV control system 300 records the latency violation and information related to the latency violation such as the number of frames that were not analyzed, a type of object detection algorithm used, parameters of that object detection algorithm, a source of the latency violation (e.g., the perception interval 302, the planning interval 308, the control interval 310, etc.), environmental conditions, etc.

During the mapping and localization interval 304, the AV control system 300 is configured to perform functions of the mapping and localization stack 114 to determine the AV's position and orientation (pose). For example, a location sensor 320 can detect a location of the AV at discrete points (e.g., every 200 ms) and provide the location data to a location buffer 322. During the mapping and localization interval 304, the AV control system 300 accesses the location data and determines the position and the orientation from changes in the location data. The AV control system 300 may be configured to store the position and orientation of the AV in a location store 324 that can be accessed in other intervals of the schedule. In some examples, the location store 324 can be configured to

After the localization interval 304, the prediction stack 116 may configure the AV control system 300 to perform the functions of and predict a path of objects in the environment. In some examples, the AV control system 300 may be configured to receive detected objects from the perception store 318 and location information in the location store 324 and predict the movement in the environment. The AV control system 300 may be configured to perform the predictions of objects in the perception store 318 during the prediction interval 306 of 16.7 ms and provide the predictions to a predictions store 326 for storage for other intervals. In some cases, some predictions cannot be performed during the prediction interval 306 based a number of factors such as environmental conditions, a number of objects stored in the perception store 318, etc. If a prediction of an object cannot be performed, the data related to the object may be maintained in the perception store 318. For example, the perception store 318 can maintain a FIFO buffer for the prediction interval 306. If the AV control system 300 is unable to perform the predictions in the prediction interval 306, the AV control system 300 must wait until the next prediction interval 306 to perform the predictions of object movement in the perception store 318.

As noted above, when the AV control system 300 is unable to perform a prediction for that interval, a latency violation occurs and the AV control system 300 may be configured to store data that identifies the latency violation in a data store 330. In one illustrative example, the AV control system 300 is configured to identify data stored in a buffer of the perception store 318 that indicates that the data from that prediction interval of that AV control schedule did not complete. In some aspects, it is also possible to store the time stamps of some or all inputs and outputs of the intervals. The time stamps can be compared to the current time to check for any latency violations. It is also possible for a latency monitor process to check for execution time of other processes and make determination of latency violation if the latency of the processes exceed a certain threshold. This threshold can be chosen based on statistics (for example latency violation if latency exceeds percentile % 99.9). The threshold can also be chosen based on safety considerations (for example, perception outputs cannot be stale more than 500 ms). The AV control system 300 records the latency violation and information related to the latency violation such as the number of detected objects that were not predicted, a source of the latency violation (e.g., the prediction interval 306, the planning interval 308, the control interval 310, etc.), environmental conditions, etc.

After the prediction interval 306, the planning interval 308 may configure the AV control system 300 to perform functions of the planning stack 118 to determine how to maneuver or operate the AV 102 safely and efficiently in its environment. In some examples, the AV control system 300 may be configured to receive detected objects from the perception store 318, location and environmental information from the location store 324, and predictions from the predictions store 326 to identify events that are occurring or will occur. Based on the current of future events, the planning interval 308 plans mechanical operations that the AV 102 can perform.

In some examples, the planning interval 308 may not receive all timely information related to detected objects, predictions, based on various latency violations from the previous intervals. A latency violation can have a cascading effect because the AV control schedule is a pipeline with each interval depending on a previous interval. Latency violations can cause the detected objects to be late (e.g., stale), predictions to be late, and plan to be late. As a result of upstream latency violations, the reaction time of the AV control system 300 increases. As reaction time increases, the AV control system 300 may be unable to identify and react to unsafe situations.

After the planning interval 308, the control interval 310 may configure the AV control system 300 to perform and functions of the control stack 122 to manage the operation of the vehicle propulsion system 130, the braking system 132, the steering system 134, the safety system 136, and the cabin system 138. The control interval 310 can receive the plans from the planning store 328 to determine parameters for the mechanical functions. During the communication interval 312, the AV control system 300 may then perform the function of the communication stack 120 to transmit and receive signals between the various stacks and other components of the AV 102 and between the AV 102, the data center 150, the client computing device 170, and other remote systems.

Although the example illustrated in FIG. 3 illustrates a sequential pipeline of intervals for the AV control system 300, other examples are possible based on parallelization of some tasks and segmenting parts of the system into synchronous functions. For example, the AV control system 300 may be implemented by a processor having multiple cores and a scheduler can be implemented that parallelizes tasks to schedule processing results to minimize the reaction time of the AV. In one illustrative example, an AV navigating a busy environment with a large number of pedestrians may allocate cores having higher instructions per cycle (IPC) to object detection functions. In another illustrative example, an AV navigating a high-speed environment may allocate cores with a higher IPC to object prediction functions. In other examples, the time duration of the various intervals may be dynamic and change based on the environment of the AV (e.g., high-speed navigation, heavy pedestrian traffic, etc.).

In some aspects, the AV control system 300 may be configured to track runtime performance of the different functions of the AV control system 300 based on current and predicted conditions. Based on the runtime performance, the AV control system 300 can predict scenarios that will cause latency violations and reduce the safety of the AV. In some aspects, based on the latency violations, the AV control system 300 may adjust various operations and parameters to reduce the latency violations. For example, the AV control system 300 receives weather information that indicates a high chance of heavy rain and the AV may determine to avoid environments with heavy pedestrian traffic or high-speed navigation environments (e.g., highways). In other examples, the runtime information may be used by a fleet management function to perform fleet management functions to assist the AV planning decisions.

In some aspects, the AV control system 300 may be configured to create heatmaps that identify different regions that indicate one or more parameters relevant to various intervals of the AV control system 300. The heatmaps may identify a computation complexity based on a combination of factors such as number of objects, pedestrian traffic, and environmental conditions. The heatmaps may also illustrate multiple dimensions using a plurality of indicators such as zones identifying objects, and vectors representing difficulty during adverse weather conditions.

FIG. 4 illustrates an example method 400 of a control system for monitoring and predicting latency violations in accordance with some examples. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method includes navigating the autonomous vehicle into a current location at block 402. For example, an AV control system 300 that is illustrated in FIG. 3 may be configured to navigate the autonomous vehicle into first region of an environment at a first time. In some examples, the AV control system 300 can be implemented in part using a processor of the computing system 700. In some examples, the AV control system 300 can be configured to receive information from one or more sensors of the AV and measure environmental information to determine environmental conditions in block 402. For example, an image sensor may be configured to detect snowflakes. In another example, the AV control system 300 may be configured to receive weather information from an external source such as a weather service. In other examples, the AV control system 300 can include a photosensor that detects lighting conditions and combines the lighting conditions with time information to determine the environmental conditions.

According to some examples, the method includes determining a runtime performance of the autonomous vehicle control system in the first region based on the environment at block 404. For example, the AV control system 300 may determine a runtime performance of the autonomous vehicle control system in the first region based on setting a counter during an AV control schedule and stop the counter when the computations of that interval are complete (or when the interval ends and computations remain pending). The AV control system 300 may also determine various events that occurred while the counter was active to determine a runtime performance. The AV control system 300 may also determine the runtime performance by comparing the timestamp of the information in the processing buffers with the current time. The AV control system 300 may also determine the runtime performance by checking the size of the memory allocated or used by the processes. The AV control system 300 may also determine the runtime performance by checking the data that is transferred in the input output channels of the AV control system 300. For example, the AV control system 300 may count a number of objects that are detected and tracked during the interval, count a number of predictions, etc. Based on the number of events and the completed time, the AV control system 300 can determine a performance runtime information. The performance runtime information can be based on the measured environmental conditions to determine how the current environment is affecting current computations within the AV control system 300.

According to other examples, the method can include additional functions related to simulating the environment based on the current runtime information. For example, at block 404, the AV control system 300 can further include determining a runtime performance of the autonomous vehicle control system in the current region based on a modification to the environment. The determination of the runtime performance can be performed by using latency or memory estimators that extrapolate the runtime performance of a small sample compute to the full workload. The determination of the runtime performance can be performed by using latency or memory estimators that are based on analytical formulas that relate the compute to runtume performance. The determination of the runtime performance can be performed by using latency or memory estimators that are based on machine learning of past runtime performance data in different environments. An example modification of modifying the environment include modifying lighting parameters or modifying the weather in the environment. The AV control system 300 can degrade a portion of the sensed information such as applying a darkening filter the images, adding noise into point cloud data from the LIDAR, or decreasing an object classification, which increases the risk of particular events occurring such as slipping in wet conditions and then perform functions associated with the corresponding interval of the AV control system. The AV control system 300 can measure one or more of these simulations and determine the time difference between the measured event and the simulated event to determine how adverse environmental conditions affect the computations. In one illustrative example, the AV control system can determine runtime information such as the number of objects that can be computed during a perception interval when the AV is navigating a heavy rain condition.

After block 404, the method includes recording (e.g., by the AV control system 300) the runtime performance into storage medium including other runtime performance information at block 406. If the AV control system 300 performs a simulation and determines runtime performance, the AV control system 300 can also record runtime information associated with the event and directly link the simulated event to the corresponding measured event.

According to some examples, the method includes generating or receiving (e.g., by the AV control system 300) the mapping information associated with the regions between the current location and the destination location based on runtime performance information in the runtime information at block 408. The mapping information may be comprised of arbitrary, 1D, 2D or 3D spatial points where each point is associated with a runtime information. The mapping information may be 1D spatial points that are parameterized based on the positions along roads or paths. In additional to the spatial dimensions, other parameters that impact the runtime performance (such as weather or lighting) can be included as other dimensions of the mapping information. The mapping information can be stored alongside of the existing HD or other maps for more convenient implementation. The mapping information can also be stored in a separate data store. The mapping information may be stored as a list of points. The mapping information may also be stored in a multi-dimensional data structure consisting of bins, where empty bins indicate no information available. During retrieval, closest values that are available may be retrieved. In some examples, the mapping information can be visualized as a heatmap that identifies various parameters effects on the runtime performance of the AV, and the mapping information can be aggregated data recorded by a fleet of AVs and synthesized into a data set that is loaded into the AV or transmitted to the AV. In some cases, a management system can store the data and use an ML model to receive runtime information from an AV and generate mapping information that corresponds to the current environmental conditions, timing, lighting, and the like and transmit the generated mapping information to the AV. The AV can receive the mapping information from the management system and use its runtime information (e.g., a plurality of runtime data points) to generate a current mapping information. In some cases, the mapping information can be stored in the AV and the AV can select a portion of mapping information and apply the current runtime information of the AV to generate a current runtime information.

The mapping information includes at least one of time information, lighting information, object density information, or weather information associated with regions between a current location and the destination location and can be in the form of a heatmap that uses color to identify one or more parameters. In one illustrative example, the AV control system 300 can transmit a request to a fleet management system for the mapping information. The mapping information can be a data structure that identifies various geographic regions and parameters of those geographic regions that can affect the latency of calculations. For example, the mapping information can identify various aspects such as average object density, average pedestrian density, and some or all of the parameters can be mapped to time information to allow the AV to use time to determine runtime performance information of the AV while navigating to the destination at a particular time. In another illustrative aspect, the AV may generate mapping information based on data stored within the AV and using the current runtime information and environmental conditions.

According to some examples, the method includes determining (e.g., by the AV control system 300) a route to a destination location for the autonomous vehicle to navigate based on at least based on mapping information at block 410. A fleet management system provides the mapping information that is static and the AV may use the determinations in the mapping information. According to other examples, the determination of the route can also use current environmental conditions in conjunction with the mapping information to identify regions where the reaction time of the AV may be inadequate. In some examples, the AV control system 300 may determine the route to the destination location in part based on the runtime performances of different routes to the destination location.

According to some examples, the method includes monitoring (e.g., by the AV control system 300) the AV control system for latency violations and controlling the AV based on latency violations while navigating to the destination location based on the route at block 412. Further details of monitoring the AV control system for latency violations and controlling the AV control system based on latency violations are described herein with reference to FIG. 5.

According to some examples, the method includes transmitting (e.g., by the AV control system 300) the runtime information to a fleet management system at block 414. The runtime information can be input into an ML model that is being trained based on the runtime information to generate the mapping information.

FIG. 5 illustrates an example method 500 of a control system for monitoring an AV control system for latency violations and controlling the AV control system based on latency violations in accordance with some examples.

While navigating to a destination location, the control system is configured to execute various parts of the AV control schedule on a cycle and may include performance-related monitors. For example, the AV control system 300 can determine that computations within a functional interval (e.g., planning interval, prediction interval, etc.) of the AV control system do not complete within that functional interval at block 502. As described above, an incomplete interval can be determined by identifying a buffer associated with the function that is empty or has data to be processed. In some cases, the interval itself can generate an interrupt when the cycle is complete to record data that indicates computations were not completed. In response to identifying an incomplete interval (or minimum functions to meet a threshold), the AV control system can record a latency violation associated with that functional interval and identify information related to unfinished computations (e.g., number of frames that have not been input into an object detector, a number of predictions unprocessed, etc.) at block 504.

In an illustrative example, during that AV control cycle or a different AV control cycle, the AV control system may determine that computations within another functional interval of the AV control system do not complete within that functional interval at block 506. In some examples, the interval can be the same (e.g., a different perception interval) or another interval of the same AV control cycle (e.g., the planning interval in the same or different AV control cycle). In response to identifying an incomplete interval (or minimum functions to meet a threshold), the AV control system can record a latency violation associated with that functional interval and identify information related to unfinished computations (e.g., number of frames that have not been input into an object detector, a number of predictions unprocessed, etc.) at block 508.

At block 510, the AV control system determines that a safety condition has been satisfied based on the latency violations stored in the runtime information. In some cases, the AV control system can determine a frequency of latency violations to identify the safety condition has been satisfied. In other examples, certain latency violations can be weighted because downstream effects from delayed computations, or jitter from the latency violations can be determined to identify the safety condition.

After the determination of the safety condition has been satisfied, the AV control system may adjust parameters of the AV control system based on the safety condition at block 512. In some examples, the parameters can vary and be related to driving operation, or can be related to processing techniques employed by the AV control system. For example, the parameters are associated with at least one of a compute fidelity, a boundary detection fidelity, and an object detection fidelity. Various parts of the AV control system can be configured to reduce computation complexity by sacrificing a small amount of accuracy. The decrease in accuracy may be insignificant as compared to delayed calculations. In other examples, at least one driving parameter of the AV may change such as the speed, a minimum distance between objects, and so forth.

At block 514, the AV control system continues to control the AV based on the adjusted parameters and continues recording latency violations. After a period of time, the AV control system can analyze latency violations occurring after adjusting the parameters to ascertain whether to tune the parameters of the AV control system at block 516. The AV control system can gradually increase or decrease the parameters to safely navigate the environment.

According to some examples, the AV control system 300 uses the mapping information and environmental conditions to safely navigate the environment during difficult environments by a combination of avoiding those difficult environments and increasing safety-related parameters to reduce unnecessary risks. The heatmaps may be data structures capable that the control system can process based on a quantity of values. For example, each data point in the heatmap can identify a plurality of values and may be represented by a complex object. In some examples, the heatmaps can be visual images that can be displayed and interpreted by a person. An example heatmap that includes visual parameters is described below in FIG. 6.

FIG. 6 illustrates an example heatmap 600 having a plurality of visual indicators that can be used by an AV control system to perform navigation functions, in accordance with some examples. In some cases, the heatmap can be in the form of a data object (e.g., a matrix such as a 2D-array of objects, a graph that connects various points together for navigation, etc.) having a plurality of parameters that can be used by a control system (e.g., the AV control system 300) to perform AV functions.

The heatmap 600 illustrates a highway 602 and several blocks east of the highway 602, including street 604, street 606, street 608, street 610 that run east to west. Street 612, street 614, and street 616 run north to south. The heatmap 600 includes a first heat zone 620 that indicates the many objects (e.g., a commercial zone) that could cause latency violations, a second heat zone 622 include some objects (e.g., a residential zone) that would likely not cause latency violations by themselves, and a third heat zone 624 that includes few objects (e.g., an industrial zone). In addition, vectors that are illustrated to be normal to the streets illustrate an additional parameter such as how environmental effects degrade sensor performance within particular regions, with the length of the vector corresponding to a larger effect on sensor performance. As described before, the heatmap 600 may have additional dimensions (third, fourth, etc.) that are not shown in FIG. 6.

In one example, an AV may be located at position A on street 616 and may need to navigate to the intersection of street 610 and street 612 identified by point B. The AV control system may determine not to navigate northward towards street 604 because the heat zone 620 has many obstructions and is not an efficient route. In one illustrative example, the AV control system may identify multiple paths to reach point B such as a first path 630, a second path 632, and a third path 634, however other paths are possible.

The first path 630 travels south on street 616, turns eastward on the street 606 and then turns southward at the street 612. The second path 632 travels south on street 616, turns eastward on street 608 and then southward on street 612. The third path 634 travels south on street 616 and then turns eastward on street 610 to arrive at point B.

In one illustrative example, the AV control system may determine that there is no adverse environmental condition that would cause latency violations, and the additional parameter illustrated by the normal vectors may not be used in the route planning. In that case, the AV may determine that the first path 630 traverses through the heat zone 622 that includes a number of objects that can cause latency violations and the AV control system may determine to prefer a route through the second heat zone 624. In this example, the AV control system may determine the third path 634 because fewer turns and because there are no adverse conditions.

In another illustrative example, the AV control system may determine that there is an adverse condition that affects the visibility of the AV's sensors, and the additional parameter illustrated by the normal vectors may be used in the route planning due to latency violations that may occur because of the adverse condition. In this illustrative example, the third path 634 includes a two-block stretch along street 610 that indicates that additional parameters, for example, due to environmental conditions, can significantly increase computation complexity of the AV control system, which may cause latency violations and affect AV driving performance. However, the second path 632 includes a section along the street 608 that indicates that the environmental conditions have a less adverse effect. In this example, the AV control system may determine to navigate from point A to point B using the second path 632 because there is less opportunity for latency violations.

FIG. 7 shows an example of computing system 700, which can be for example any computing device for training or executing a neural network, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) 710 and connection 705 that couples various system components including system memory 715, such as read-only memory (ROM) 720 and random access memory (RAM) 725 to processor 710. Computing system 700 can include a cache of high-speed memory 712 connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement, and therefore the basic features here may easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, RAMs, ROM, and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

The computing system 700 can also include a graphical processing unit (GPU) array 750 or any similar processor for performing massively complex and parallel mathematical operations such as simulations, games, neural network training, and so forth. The GPU array 750 includes at least one GPU and is illustrated to have three GPUs comprising GPU 752, GPU 754, and GPU 756. However, the GPU array 750 can be any number of GPUs. In some examples, the GPU core can be integrated into a die of the processor 710.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:

Aspect 1. A computer-implemented method, comprising: navigating an AV into a first location of an environment at a first time; determining a runtime performance of a control system of the AV at the first location; recording the runtime performance into a data store of the AV, wherein the data store includes runtime performance of the control system at previous locations; determining current mapping information based on the runtime performance and based on previous mapping information including runtime performance of the AV at different locations; and determining a route to a destination location for the AV based on the current mapping information.

Aspect 2. The computer-implemented method of Aspect 1, wherein the determining the route to the destination location comprises: determining runtime performances of different routes to the destination location based on the current mapping information and current environmental information, wherein the current mapping information includes at least one of time information, lighting information, object density information, or weather information associated with regions between a current location and the destination location, and wherein the current environmental information includes measured information related to at least one information of the current mappying information; and determining the route to the destination location in part based on the runtime performances of different routes to the destination location.

Aspect 3. The computer-implemented method of any of Aspects 1 to 2, further comprising: generating the previous mapping information based on runtime performance information in the data store.

Aspect 4. The computer-implemented method of any of Aspects 1 to 3, further comprising: receiving the previous mapping information from a management system.

Aspect 5. The computer-implemented method of any of Aspects 1 to 4, further comprising: measuring environmental conditions using at least one sensor of the AV; and recording the environmental conditions into the data store with the runtime performance.

Aspect 6. The computer-implemented method of any of Aspects 1 to 5, wherein the environmental conditions comprise at least one of lighting or weather.

Aspect 7. The computer-implemented method of any of Aspects 1 to 6, further comprising: determining a runtime performance of the control system at the first location based on a modification to the environment; and recording the runtime performance based on the modification of the environment into the data store.

Aspect 8. The computer-implemented method of any of Aspects 1 to 7, wherein the modification comprises modifying light in the environment.

Aspect 9. The computer-implemented method of any of Aspects 1 to 8, wherein the modification comprises modifying weather in the environment.

Aspect 10. The computer-implemented method of any of Aspects 1 to 9, further comprising: determining that computations within a functional interval of the control system do not complete within the functional interval; recording a latency violation associated with the functional interval.

Aspect 11. The computer-implemented method of any of Aspects 1 to 10, further comprising: determining that computations within another functional interval of the control system does not complete within the other functional interval; and recording a latency violation associated with the other functional interval.

Aspect 12. The computer-implemented method of any of Aspects 1 to 11, further comprising: determining a safety condition has been satisfied based on latency violations at a second time; adjusting parameters for the control system based on the safety condition; and operating the control system based on the parameters for the control system.

Aspect 13. The computer-implemented method of any of Aspects 1 to 12, wherein the safety condition comprises a quantity of latency violations within a time period.

Aspect 14. The computer-implemented method of any of Aspects 1 to 13, wherein the latency violations are recorded by different functions of the control system.

Aspect 15. The computer-implemented method of any of Aspects 1 to 14, further comprising: tuning the parameters of the control system based on latency violations occurring after the second time.

Aspect 16. The computer-implemented method of any of Aspects 1 to 15, wherein the parameters are associated with at one least one of a compute fidelity, a boundary detection fidelity, at least one driving parameter, and an object detection fidelity.

Aspect 17. The computer-implemented method of any of Aspects 1 to 16, further comprising: transmitting runtime performance information in the data store to a management system, wherein an ML model is trained based on the runtime performance information to generate the previous mapping information.

Aspect 18: An AV includes a storage (implemented in circuitry) configured to store instructions and a processor. The processor configured to execute the instructions and cause the processor to: navigate an AV into a first location of an environment at a first time; determine a runtime performance of a control system of the AV at the first location; record the runtime performance into a data store of the AV, wherein the data store includes runtime performance of the control system at previous locations; determine current mapping information based on the runtime performance and based on previous mapping information including runtime performance of the AV at different locations; and determine a route to a destination location for the AV based on the current mapping information.

Aspect 19: The AV of Aspect 18, wherein the processor is configured to execute the instructions and cause the processor to: determine runtime performances of different routes to the destination location based on the current mapping information and current environmental information, wherein the current mapping information includes at least one of time information, lighting information, object density information, or weather information associated with regions between a current location and the destination location, and wherein the current environmental information includes measured information related to at least one information of the current mappying information; and determine the route to the destination location in part based on the runtime performances of different routes to the destination location.

Aspect 20: The AV of any of Aspects 18 to 19, wherein the processor is configured to execute the instructions and cause the processor to: generate the previous mapping information based on runtime performance information in the data store.

Aspect 21: The AV of any of Aspects 18 to 20, wherein the processor is configured to execute the instructions and cause the processor to: receive the previous mapping information from a management system.

Aspect 22: The AV of any of Aspects 18 to 21, wherein the processor is configured to execute the instructions and cause the processor to: measure environmental conditions using at least one sensor of the AV; and record the environmental conditions into the data store with the runtime performance.

Aspect 23: The AV of any of Aspects 18 to 22, wherein the environmental conditions comprise at least one of lighting or weather.

Aspect 24: The AV of any of Aspects 18 to 23, wherein the processor is configured to execute the instructions and cause the processor to: determine a runtime performance of the control system at the first location based on a modification to the environment; and record the runtime performance based on the modification of the environment into the data store.

Aspect 25: The AV of any of Aspects 18 to 24, wherein the modification comprises modifying light in the environment.

Aspect 26: The AV of any of Aspects 18 to 25, wherein the modification comprises modifying weather in the environment.

Aspect 27: The AV of any of Aspects 18 to 26, wherein the processor is configured to execute the instructions and cause the processor to: determine that computations within a functional interval of the control system do not complete within the functional interval; record a latency violation associated with the functional interval.

Aspect 28: The AV of any of Aspects 18 to 27, wherein the processor is configured to execute the instructions and cause the processor to: determine that computations within another functional interval of the control system does not complete within the other functional interval; and record a latency violation associated with the other functional interval.

Aspect 29: The AV of any of Aspects 18 to 28, wherein the processor is configured to execute the instructions and cause the processor to: determine a safety condition has been satisfied based on latency violations at a second time; adjust parameters for the control system based on the safety condition; and operate the control system based on the parameters for the control system.

Aspect 30: The AV of any of Aspects 18 to 29, wherein the safety condition comprises a quantity of latency violations within a time period.

Aspect 31: The AV of any of Aspects 18 to 30, wherein the latency violations are recorded by different functions of the control system.

Aspect 32: The AV of any of Aspects 18 to 31, wherein the processor is configured to execute the instructions and cause the processor to: tune the parameters of the control system based on latency violations occurring after the second time.

Aspect 33: The AV of any of Aspects 18 to 32, wherein the parameters are associated with at one least one of a compute fidelity, a boundary detection fidelity, at least one driving parameter, and an object detection fidelity.

Aspect 34: The AV of any of Aspects 18 to 33, wherein the processor is configured to execute the instructions and cause the processor to: transmit runtime performance information in the data store to a management system, wherein an ML model is trained based on the runtime performance information to generate the previous mapping information.

Aspect 35: A computer readable medium comprising instructions using a computer system. The computer includes a memory (e.g., implemented in circuitry) and a processor (or multiple processors) coupled to the memory. The processor (or processors) is configured to execute the computer readable medium and cause the processor to: navigate an AV into a first location of an environment at a first time; determine a runtime performance of a control system of the AV at the first location; record the runtime performance into a data store of the AV, wherein the data store includes runtime performance of the control system at previous locations; determine current mapping information based on the runtime performance and based on previous mapping information including runtime performance of the AV at different locations; and determine a route to a destination location for the AV based on the current mapping information.

Aspect 36: The computer readable medium of Aspect 35, wherein the processor is configured to execute the computer readable medium and cause the processor to: determine runtime performances of different routes to the destination location based on the current mapping information and current environmental information, wherein the current mapping information includes at least one of time information, lighting information, object density information, or weather information associated with regions between a current location and the destination location, and wherein the current environmental information includes measured information related to at least one information of the current mappying information; and determine the route to the destination location in part based on the runtime performances of different routes to the destination location.

Aspect 37: The computer readable medium of any of Aspects 35 to 36, wherein the processor is configured to execute the computer readable medium and cause the processor to: generate the previous mapping information based on runtime performance information in the data store.

Aspect 38: The computer readable medium of any of Aspects 35 to 37, wherein the processor is configured to execute the computer readable medium and cause the processor to: receive the previous mapping information from a management system.

Aspect 39: The computer readable medium of any of Aspects 35 to 38, wherein the processor is configured to execute the computer readable medium and cause the processor to: measure environmental conditions using at least one sensor of the AV; and record the environmental conditions into the data store with the runtime performance.

Aspect 40: The computer readable medium of any of Aspects 35 to 39, wherein the environmental conditions comprise at least one of lighting or weather.

Aspect 41: The computer readable medium of any of Aspects 35 to 40, wherein the processor is configured to execute the computer readable medium and cause the processor to: determine a runtime performance of the control system at the first location based on a modification to the environment; and record the runtime performance based on the modification of the environment into the data store.

Aspect 42: The computer readable medium of any of Aspects 35 to 41, wherein the modification comprises modifying light in the environment.

Aspect 43: The computer readable medium of any of Aspects 35 to 42, wherein the modification comprises modifying weather in the environment.

Aspect 44: The computer readable medium of any of Aspects 35 to 43, wherein the processor is configured to execute the computer readable medium and cause the processor to: determine that computations within a functional interval of the control system do not complete within the functional interval; record a latency violation associated with the functional interval.

Aspect 45: The computer readable medium of any of Aspects 35 to 44, wherein the processor is configured to execute the computer readable medium and cause the processor to: determine that computations within another functional interval of the control system does not complete within the other functional interval; and record a latency violation associated with the other functional interval.

Aspect 46: The computer readable medium of any of Aspects 35 to 45, wherein the processor is configured to execute the computer readable medium and cause the processor to: determine a safety condition has been satisfied based on latency violations at a second time; adjust parameters for the control system based on the safety condition; and operate the control system based on the parameters for the control system.

Aspect 47: The computer readable medium of any of Aspects 35 to 46, wherein the safety condition comprises a quantity of latency violations within a time period.

Aspect 48: The computer readable medium of any of Aspects 35 to 47, wherein the latency violations are recorded by different functions of the control system.

Aspect 49: The computer readable medium of any of Aspects 35 to 48, wherein the processor is configured to execute the computer readable medium and cause the processor to: tune the parameters of the control system based on latency violations occurring after the second time.

Aspect 50: The computer readable medium of any of Aspects 35 to 49, wherein the parameters are associated with at one least one of a compute fidelity, a boundary detection fidelity, at least one driving parameter, and an object detection fidelity.

Aspect 51: The computer readable medium of any of Aspects 35 to 50, wherein the processor is configured to execute the computer readable medium and cause the processor to: transmit runtime performance information in the data store to a management system, wherein an ML model is trained based on the runtime performance information to generate the previous mapping information.

What is claimed is:

1. A computer-implemented method, comprising:
navigating an autonomous vehicle (AV) into a first location of an environment at a first time;
determining a runtime performance of a control system of the AV at the first location;
recording the runtime performance into a data store of the AV, wherein the data store includes runtime performance of the control system at previous locations;
determining current mapping information based on the runtime performance and based on previous mapping information including runtime performance of the AV at different locations; and
determining a route to a destination location for the AV based on the current mapping information.

2. The computer-implemented method of claim 1, wherein the determining the route to the destination location comprises:
determining runtime performances of different routes to the destination location based on the current mapping information and current environmental information, wherein the current mapping information includes at least one of time information, lighting information, object density information, or weather information associated with regions between a current location and the destination location, and wherein the current environmental information includes measured information related to at least one information of the current mappying information; and
determining the route to the destination location in part based on the runtime performances of different routes to the destination location.

3. The computer-implemented method of claim 2, further comprising:
generating the previous mapping information based on runtime performance information in the data store.

4. The computer-implemented method of claim 2, further comprising:
receiving the previous mapping information from a management system.

5. The computer-implemented method of claim 1, further comprising:
measuring environmental conditions using at least one sensor of the AV; and
recording the environmental conditions into the data store with the runtime performance.

6. The computer-implemented method of claim 5, wherein the environmental conditions comprise at least one of lighting or weather.

7. The computer-implemented method of claim 1, further comprising:
determining a runtime performance of the control system at the first location based on a modification to the environment; and
recording the runtime performance based on the modification of the environment into the data store.

8. The computer-implemented method of claim 7, wherein the modification comprises modifying light in the environment.

9. The computer-implemented method of claim 7, wherein the modification comprises modifying weather in the environment.

10. The computer-implemented method of claim 1, further comprising:
determining that computations within a functional interval of the control system do not complete within the functional interval;
recording a latency violation associated with the functional interval.

11. The computer-implemented method of claim 10, further comprising:
determining that computations within another functional interval of the control system does not complete within the other functional interval; and
recording a latency violation associated with the other functional interval.

12. The computer-implemented method of claim 10, further comprising:
determining a safety condition has been satisfied based on latency violations at a second time;
adjusting parameters for the control system based on the safety condition; and
operating the control system based on the parameters for the control system.

13. The computer-implemented method of claim 12, wherein the safety condition comprises a quantity of latency violations within a time period.

14. The computer-implemented method of claim 13, wherein the latency violations are recorded by different functions of the control system.

15. The computer-implemented method of claim 14, further comprising: tuning the parameters of the control system based on latency violations occurring after the second time.

16. The computer-implemented method of claim 14, wherein the parameters are associated with at one least one of a compute fidelity, a boundary detection fidelity, at least one driving parameter, and an object detection fidelity.

17. The computer-implemented method of claim 1, further comprising:
transmitting runtime performance information in the data store to a management system, wherein a machine learning (ML) model is trained based on the runtime performance information to generate the previous mapping information.

18. An autonomous vehicle (AV), comprising:
a storage configured to store instructions;
a processor configured to execute the instructions and cause the processor to:
navigate the AV into first location of an environment at a first time;
determine a runtime performance of a control system of the AV at the first location;
record the runtime performance into a data store of the AV;
determining current mapping information based on the runtime performance and based on previous mapping information including runtime performance of the AV at different locations; and
determine a route to a destination location for the AV based on the current mapping information.

19. The AV of claim 18, wherein the processor is further configured to:
determine that computations within a functional interval of the control system do not complete within the functional interval;
recording a latency violation associated with the functional interval.

20. The AV of claim 19, wherein the processor is further configured to:
determine a safety condition has been satisfied based on latency violations at a second time;
adjust parameters for the control system based on the safety condition, wherein the parameters are associated with at one least one of a compute fidelity, a boundary detection fidelity, at least one driving parameter, and an object detection fidelity; and
operating the control system based on the parameters for the control system.
